(19) United States
(12) Patent Application Publication
(10) Pub. No.: US 2018/0047200 A1
(43) Pub. Date: Feb. 15, 2018

(54) COMBINING USER IMAGES AND COMPUTER-GENERATED ILLUSTRATIONS TO PRODUCE PERSONALIZED ANIMATED DIGITAL AVATARS

(71) Applicant: JIBJAB MEDIA INC., Los Angeles, CA (US)

(72) Inventors: Chris O'Hara, Venice, CA (US); Mauro Gatti, Venice, CA (US); Alex Zaldivar, Lake Balboa, CA (US); Gregg Spiridellis, Manhattan Beach, CA (US); Michael Bracco, Marina del Rey, CA (US); Bradley Roush, Long Beach, CA (US)

(73) Assignee: JIBJAB MEDIA INC., Los Angeles, CA (US)

(21) Appl. No.: 15/234,847

(22) Filed: Aug. 11, 2016

(51) Int. Cl. G06T 13/40; G06T 3/40; G06T 3/60; G06K 9/00

(52) U.S. Cl. CPC G06T 13/40; G06K 9/00248; G06T 3/40; G06T 3/60; G06K 9/00281; G06F 3/04845

(57) ABSTRACT

Animated frames may illustrate an animated face that has one or more facial features that change during the animation. Each change may be between a photographed facial feature of a real face and a corresponding drawn facial feature of a drawn face. Various related methods are also disclosed.

### BACKGROUND

### Technical Field

This disclosure relates to the production of digital animated images, such as digital avatars that may be used as emojis, and to the customization of such images.

### Description of Related Art

Computer software applications allow users to create customized digital avatars by selecting various components included with the applications. The digital avatar may be a 2D or 3D cartoon that resembles, but may not be identical to, the user. The digital avatars may be either animated or still images and can be delivered as part of an instant or text message, such as in the form of an emoji, or shared on social media platforms. The digital avatar may be stored in a file, alone or with other information, such as in a .jpeg, .gif or .mp4 file.

The computer software application may provide a standard template for the digital avatar. Users may then customize this standard template and personalize the digital avatar by, for example, choosing a gender, adding accessories and clothes, choosing a hairstyle and a face shape, and modifying the skin color of the digital avatar. The computer software application may then take this customized avatar, add animation or text, and present the user with different image file types that the user can share with others, such as by using one of the methods described above.

These software applications, however, may not be ideal. For example, the customized avatar that the application creates may still not look very similar to the user. In addition, the application may lack the illusion of animating the user's real face, which has more personalization and expression of emotion.

### SUMMARY

A non-transitory, tangible, computer-readable storage media may contain a computer file that may contain a set of animation frames. When displayed sequentially, the animated frames may illustrate an animated face that has one or more facial features that change during the animation. Each change may be between a photographed facial feature of a real face and a corresponding drawn facial feature of a drawn face.

The one or more facial features that change may include the eyes, mouth, nose, eyebrows, and/or eyeglasses.

The expression of the face may change during the animation.

At least one of the animation frames may be of a face without a nose and/or without one or more other facial features.

All of the frames may include one or more of the facial features of the photographed image of the face.

An automated method may display a photographed image of a real face centered within a pre-determined border. The method may include a computer data processing system having a processor: receiving image data that includes a photographed image of a real face; detecting the size and location of the real face within the photographed image; superimposing a pre-determined border on the photographed image; adjusting the size and location of the photographed image of the real face relative to the pre-determined border automatically and without user input during the adjusting so as to cause the photographed image of the real face to be centered within and to fill the area within the pre-determined border; and displaying the real face centered within and filling the area within the pre-determined border.

The computer data processing system may also: rotate the photographed image of the real face with respect to the pre-determined border so that the eyes in the real face are centered about the same horizontal axis; and display the photographed image of the real face within the pre-determined border with the eyes in the real face centered about the same horizontal axis.

A method may generate a computer file that may contain a set of animation frames that, when displayed sequentially, may illustrate an animated face. The method may include a computer data processing system having a processor: receiving template data indicative of a set of template animation frames, each having a template face, that, when displayed sequentially, illustrate a template animated face; reading customization data indicative of one or more desired changes to at least one of the template animated frames, including the substitution of a photographed image of a real face for the template animated face in the template animated frame; and generating a computer file that contains a set of animation frames that, when displayed sequentially, illustrate an animated face that has all of the features of the template animated face, except for the changes dictated by the customizing data.

The set of animation frames, when displayed sequentially, may illustrate an animated face that has one or more facial features that change during the animation, each change being between a facial feature in the photographed image of the real face and a corresponding drawn facial feature of a face.

A method may generate a computer file that contains an image of a real face. The method may include a computer data processing system having a processor: receiving data indicative of a photographed image of a real face; changing the size of at least one but not all of the features in the real face automatically and without user input during the changing; and generating a computer file containing the data indicative of a photographed image of a face, but with the changed size of the at least one but not all of the features in the real face.

One of the features of the real face whose size is changed may be the eyes of the real face.

The method may include the computer data processing system smoothing the skin of the photographed image of the real face. The generated computer file may include the smoothened skin of the photographed image.

A method may generate a computer file that contains an image of a real face. The method may include a computer data processing system having a processor: receiving data indicative of a photographed image of a real face; presenting a linked sequence of user interface screens, each user interface screen allowing a user to modify a different feature of the photographed image of the real face; receiving one or more user instructions to modify the image of the real face during the presenting of the user interface screens; and generating a computer file that contains the image of the real face, modified as specified by the user instructions.

The generated computer file may contain a set of animation frames that, when displayed sequentially, illustrate an animation of the real face. At least one of the frames may include the modifications specified by the one or more user instructions.

One of linked sequences of user interface screens may present a proposed default shape for the face, hairstyle above the face, smoothness for the skin of the face, and/or lighting for the face that is/are automatically set by the computer data processing system and that allows the user to modify this proposed default shape, hairstyle, smoothness, and/or lighting; one of the received user instructions may be to modify the proposed default shape, hairstyle, smoothness, and/or lighting; and the computer file may contain the image of the real face with the modification to its shape, hairstyle, smoothness, and/or lighting and any other modifications dictated by the user instructions.

One of linked sequences of user interface screens may present a proposed default avatar having the real face and other skin of the avatar having a proposed default color that is automatically set by the computer data processing system and that allows the user to modify this proposed default color; one of the received user instructions may be to modify the proposed default color of the other skin of the avatar; and the computer file may contain the image of the avatar with the modification to the proposed default color of the other skin of the avatar and any other modifications dictated by the user instructions.

One of linked sequences of user interface screens may present a proposed default avatar having the real face and a proposed default shape for a body of the avatar that is automatically set by the computer data processing system and that allows the user to modify this proposed default shape; one of the received user instructions may be to modify the proposed default shape of the body of the avatar; and the computer file may contain the image of the avatar with the modification to the proposed default shape of the body of the avatar and any other modifications dictated by the user instructions.

A method may generate a computer file that may contain a set of animation frames that, when displayed sequentially, illustrate an animated avatar. The method may include a computer data processing system having a processor: receiving data indicative of a photographed image of a real face; locating an eye within the photographed image of the real face; identifying a color of the located eye; and generating a computer file that contains a set of animation frames that, when displayed sequentially, illustrate an animated avatar that includes at least portions of the photographed image of the real face, and at least one of the animation frames having drawn eyes of the same color as the identified color of the located eye.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIGS. 1-14 illustrate an example of a series of user interface screens that may be presented by a computer software application that enables a user to create a customized animated avatar that includes a photographed image of a face.

FIG. 1 illustrates an example of a face capture and centering step that may be presented to the user that may allow the user to capture and center a face for the avatar.

FIG. 2 illustrates an example of a face image selection step that may be presented to the user that may allow the user to select a face for the avatar.

FIG. 3 illustrates an example of a face shape selection and customization step that may be presented to the user that may allow the user to select and customize a shape of the face of the avatar.

FIG. 4 illustrates an example of a selectable menu of customization options that may be presented to the user that may allow the user to select an option to customize.

FIG. 5 illustrates an example of a face tuning customization step that may be presented to the user that may allow the user to customize features of the face of the avatar, such as smoothness and lighting.

FIGS. 6 and 7 illustrate an example of a skin color customization step that may be presented to the user that may allow the user to select a color for the skin of the avatar.

FIG. 8 illustrates an example of a hairstyle selection step that may be presented to the user that may allow the user to select a hairstyle for the avatar.

FIG. 9 illustrates an example of a hair color selection step that may be presented to the user that may allow the user to select a color for the selected hairstyle of the avatar.

FIG. 10 illustrates an example of a glasses selection step that may be presented to the user that may allow the user to select a style of eyeglasses for the avatar.

FIG. 11 illustrates an example of an eyeglasses color selection step that may be presented to the user that may allow the user to select a color for the eyeglasses of the avatar.

FIG. 12 illustrates an example of a body shape customization step that may be presented to the user that may allow the user to customize the shape of the body of the avatar.

FIG. 13 illustrates an example of a clothing color customization step that may be presented to the user that may allow the user to customize the color of various articles of clothing worn by the avatar.

FIG. 14 are examples of various animated avatar previews that the software application may create and present based on the customization selections made by the user during the steps illustrated in FIGS. 1-13.

FIGS. 15A-15F are some of the frames that comprise the example avatar animation 1401 illustrated in FIG. 14.

FIGS. 16A-16F are some of the frames that comprise the example avatar animation 1403 illustrated in FIG. 14.

FIGS. 17A-17D are some of the frames that comprise the example avatar animation 1405 illustrated in FIG. 14.

FIGS. 18A-18F are some of the frames that comprise the example avatar animation 1407 illustrated in FIG. 14.

FIG. 19 is an example of a flow diagram of a process that may be followed to create and share a customized animated digital avatar that includes a photographed image of a face.

FIG. 20 is an example of a flow diagram of automated steps in a process that may be followed to create and store a customized animated digital avatar that includes a photographed image of a face.

FIG. 21 is an example of a flow diagram of steps in a process that may be followed by a user to customize different features of the digital avatar.

FIG. 22 is an example of a flow diagram of steps in a process that may be followed by a user to create an animated digital avatar by combining different file types in a render library.

FIG. 23 is an example of a flow diagram of steps in a process that may be followed in connection with a render library to combine different file types to create a collection of frames for animating a digital avatar.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

A method for creating animated digital avatars, such as digital avatars that may be used as an emoji in messages, may allow a user to incorporate an image of their choosing as the face of the avatar. A computer software application may use an algorithm to determine specifications and apply features to the incorporated image, such as, for example, smoothing, face shape, skin color, and eye color. The software may use an algorithm to transform the image to resemble a 2D cartoon illustration. The software may combine the incorporated image with a 2D illustrated body to create a digital avatar.

The software may allow the user to customize the digital avatar by, for example, smoothing out the incorporated image, adjusting the face shape, and enlarging different aspects of the incorporated image. The software may allow the user to customize the digital avatar by adding different features to the incorporated image, such as, for example, glasses, hats, or hairstyles. The software may allow the user to customize the digital avatar by adjusting features of the 2D illustrated body, such as, for example, its gender, body type, and skin color.

The software may generate 2D illustrated images by translating and rendering the different features of the incorporated image, such as, for example, face shape, skin color, eye color, and hairstyle, into 2D illustrated images. The software may combine the computer-generated 2D illustrated images and the digital avatar to create animated digital avatars, such as, for example, a digital avatar with animated facial expressions. The software may allow the user to send and share the created animated digital avatars, such as, for example, as an emoji in instant messages, text, or other social media platforms.

The software may host .swf file types on a local device, such as a mobile device. The software may retrieve and interpret specifications from a database, such as, for example, hairstyle, skin color, eye color, clothing color, and accessories. The software may combine the .swf file type and the retrieved specifications from the database in a render library to create a .plist file type. The render library may render the .plist into a collection of frames that make up a 2D animation. The render library may render the collection of frames of 2D animation into a file type supported by various graphic processing units of various mobile phones and desktop computer devices.

The software may allow the user to upload an image of their choosing or to take a picture using a camera for incorporation into the avatar. The software may use an algorithm to transform the incorporated image by selecting specified features and adjusting their specifications, such as their size, automatically, without any input from the user.

The software may produce a computer-generated animation by combining the digital avatar and 2D illustrated images into a collection of frames and by rendering the collection in a timed sequence to create, for example, a digital avatar with animated facial expressions. The software may allow the user to use a slider to adjust the size, lighting, and placement of the image. The software may allow the user to use a slider to adjust the shape of the image to fit the digital avatar. The software may allow the user to customize the digital avatar by adding different features, such as, for example, glasses, hairstyle, and skin color. The software may allow the user to choose, for example, the skin color, body type, and gender of the digital avatar. The software may produce and render the animated digital avatar and allow the user to send and share the animated digital avatar through different mediums, such as in the form of an emoji. The software may have the ability to add, subtract or replace and customize static or animated digital avatars through user-defined parameters.

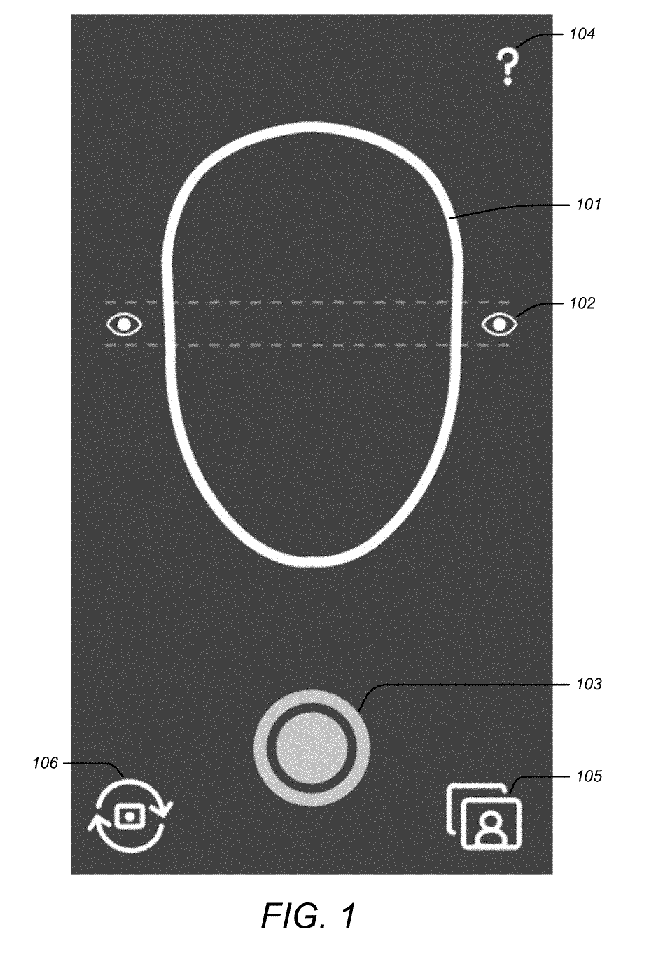

FIGS. 1-14 illustrate an example of a series of user interface screens that may be presented by a computer software application that enable a user to create a customized animated avatar that includes a photographed image of a face.

FIG. 1 illustrates an example of a face capture and centering step that may be presented to the user that may allow the user to capture and center a face for the avatar.

As illustrated in FIG. 1, a user may select whether to use a front or rear facing camera that may both be in a mobile device by tapping a user actuated control, such as a camera selection button 106.

After selecting the desired camera, the user may actuate a user control, such as a camera snap button 103. This may activate the selected camera, that may then be used to take a picture of either the user's face or another person's face.

Before capturing the image of the face, the user may adjust the direction, rotation, zoom, and/or distance of the camera until the image of the targeted face is centered within and fills a pre-determined border 101 and the eyes of the face are both on the same horizontal line and centered within an eye level indicator, such as an eye level slot 102.

In addition or instead, the software application may include user-controls that allow the user to adjust the size, location, and/or rotation of the image of the face with respect to the pre-determined border 101 and the eye level slot 102 after the image is captured, so as to cause the image of the face to be centered within and fill the pre-determined border 101 and the eyes of the face to be both on the same horizontal line and centered within the eye level indicator.

In addition or instead, the software application may itself automatically and without user input detect the size, location, and/or rotation of the face in the image and, automatically and without user input, adjust one or more of the same, either before or after the image is captured, so as to cause the image of the face to be centered within and fill the pre-determined border 101 and the eyes of the face to be both on the same horizontal line and centered within the eye level indicator.

The computer software application may use any type of image recognition algorithms to make these automated adjustments. For example, the software may detect a face within an image by scanning for different facial features, such as a nose or eyes, by comparing parts of the image to a database of images of facial features, and then by placing a rectangular border around the predicted area of the face using an algorithm to calculate the size of the face in relation to the detected facial feature. This step may be accomplished, for example, by using a commercial product that can be purchased or licensed, such as the commercially-available application program interface “Core Image” offered by Apple Inc., which is more fully described on Apple's website. The computer software application may then automatically adjust the size and orientation of the detected face to fit within the pre-determined border 101. This may be accomplished by using an algorithm to apply changes to the detected face. This step may be accomplished, for example, by using a commercial product that can be purchased or licensed, such as the commercially-available application program interface “Core Graphics” offered by Apple Inc., which is more fully described on Apple's website.

Instead of capturing a new image, the user can instead choose to upload a previously captured image of a face or any other image by actuating a user-actuated control, such as an image upload button 105. All of the centering steps that have just been described, both manual and automatic, may then be applied to the uploaded image.

The captured or selected image may be stored in storage, including any adjustments that have been made to its size, position, and orientation.

At any time, the user may actuate a user-actuated control, such as a help button 104, following which helpful guidance may be provided.

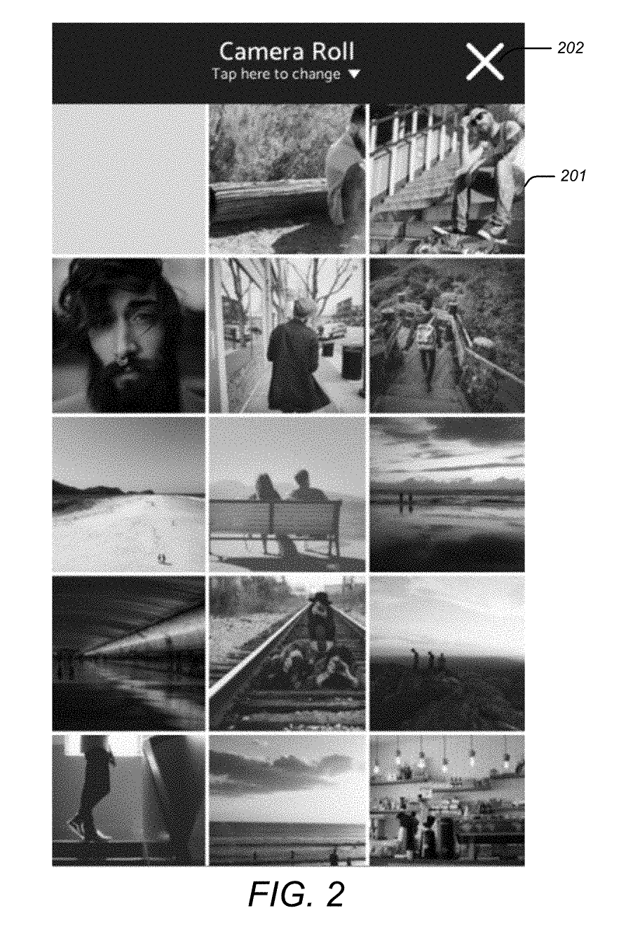

FIG. 2 illustrates an example of a face image selection step that may be presented to the user that may allow the user to select a face for the avatar. This screen may appear in response to actuating the upload button 105. As illustrated in FIG. 2, the software application may display a set of images, such as a set of images contained in a folder selected by the user or used by a camera. The user may then select a particular image that bears the face that is desired for the avatar, such as an image 201, from, for example, local storage of a mobile device running the software application, to incorporate into the digital avatar. This image may then be stored in the computer running the software application and/or used in the positioning step illustrated in FIG. 1 and described above. The user may move to the next step of the process by actuating a user-actuated control, such as close screen “X” 202.

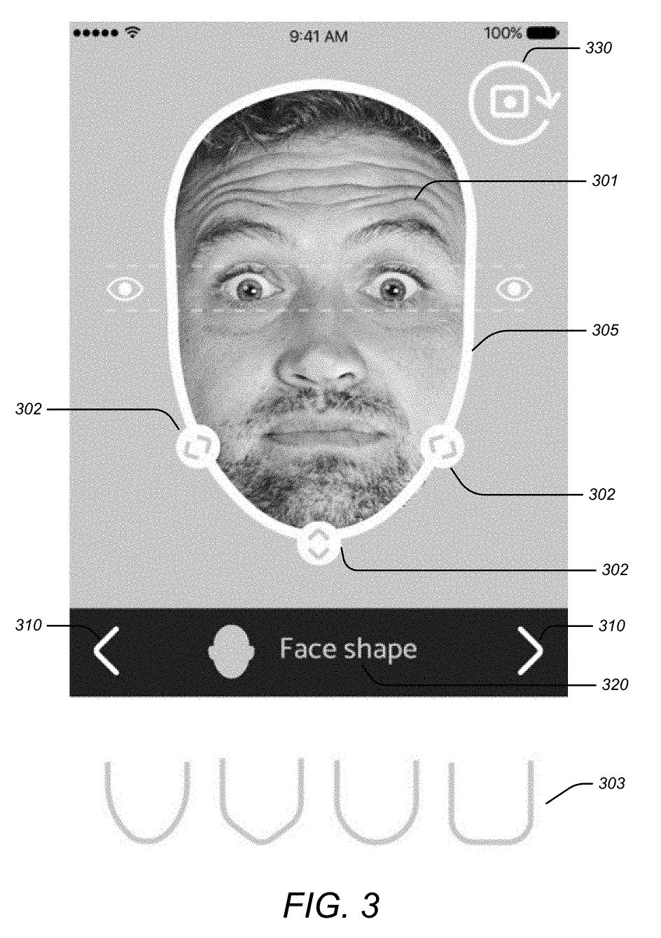

FIG. 3 illustrates an example of a face shape selection and customization step that may be presented to the user that may allow the user to select and customize a shape of the face of the avatar. This screen may automatically appear after the user selects or captures a face image and adjusts its position, size, and/or rotation using the process illustrated in FIG. 1 and, optionally, FIG. 2.

As illustrated in FIG. 3, the user may choose a face shape 303 that may be used to generate a border 305 that crops a selected or captured face image 301 after its size, position, and rotation have been adjusted. The software application may allow these adjustments to be made after the face shape is selected, either in addition or instead. The user can customize the border 305 around the image 301 by, for example, widening or narrowing it by, for example, dragging one or more border change buttons 302.

The user can choose to take a different picture of a face by actuating a user-actuated control, such as a camera icon 330.

After completing the selection and customization of a face shape, the user may actuate a user-operated control to step to the next or previous customization option, such as by tapping a forward or reverse arrow button 310. The user may in addition or instead actuate a user-operated control to call up a menu of customization options and then directly go to the desired option by selecting it from the menu. For example, the user may tap the current customization option, such as a “Face shape” 320 label, to call up this menu.

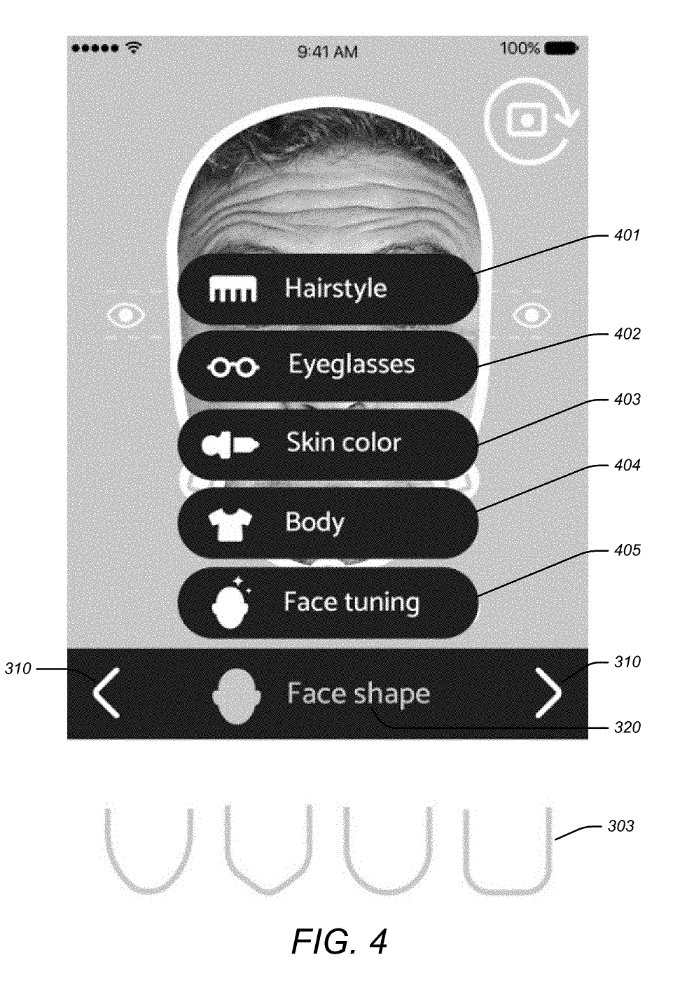

FIG. 4 illustrates an example of a selectable menu of customization options that may be presented to the user that may allow the user to select an option to customize. This menu may be activated at any time during the customization process by the user clicking a user-actuated control, such as the currently selected customization option, such as by tapping the “Face shape” 320 label. The user may then select any other desired customization option, such as a hairstyle button 401, an eyeglasses button 402, a skin color button 403, a body button 404, or a face tuning button 405, to customize the item indicated by that entry. An example of the consequences of selecting one of these other options are described below.

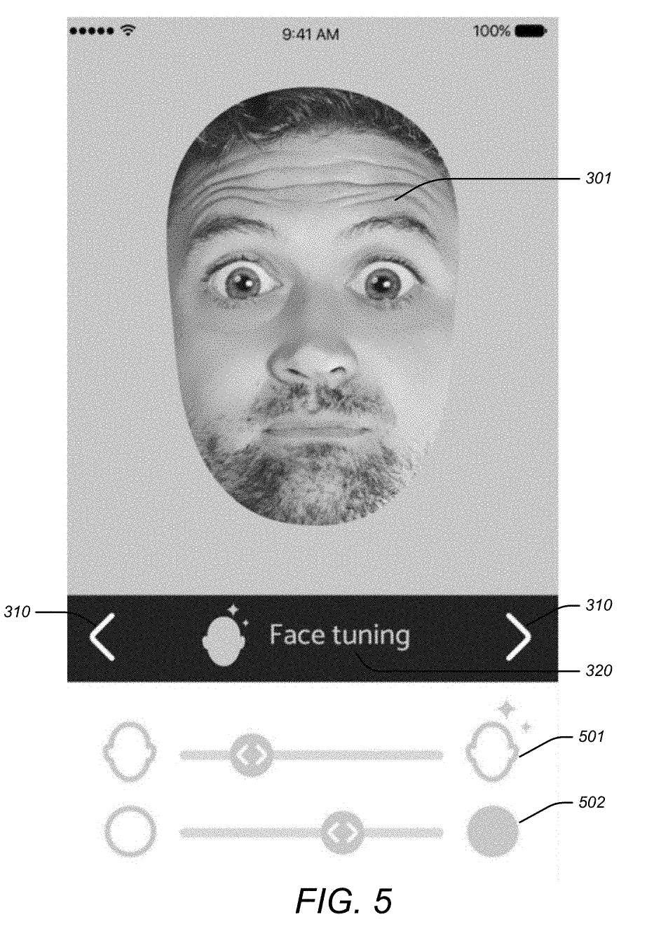

FIG. 5 illustrates an example of a face tuning customization step that may be presented to the user that may allow the user to customize features of face of the avatar, such as smoothness and lighting. As illustrated in FIG. 5, the user may customize the smoothness of the image 301 by adjusting a user-operated control, such as a smoothness slider 501, and/or may adjust the brightness of the image 301 by adjusting a user-operated control, such as a lighting slider 502. The smoothness slider 501 may also adjust the size of one or more features of the face, such as the eyes, nose, or mouth, without adjusting the size of one or more other features of the face, thus intentionally distorting the proportional size of one or more facial features.

A user-operated control may also be provided to increase or decrease the size of one or more features of the face, such as the eyes, nose, or mouth, without adjusting the size of one or more other features of the face, thus intentionally distorting the proportional size of one or more facial features. The software application may in addition or instead be configured to automatically and without user prompting make one or more of these size adjustments. For example, the computer software application might automatically enlarge the eyes of the face. To do so, the computer software application may use facial detection to detect the eyes and applying image effects to adjust only the selected features of the face. This step may be accomplished by implementing a commercial product that can be purchased or licensed, such as the commercially-available application program interface “Core Image” offered by Apple Inc., which is more fully described on Apple's website.

The user may continue to progress backwards or forwards through the customization options of the computer software application by using the arrow buttons 310 or by clicking on the current option and selecting another, as explained above in connection with FIGS. 3 and 4.

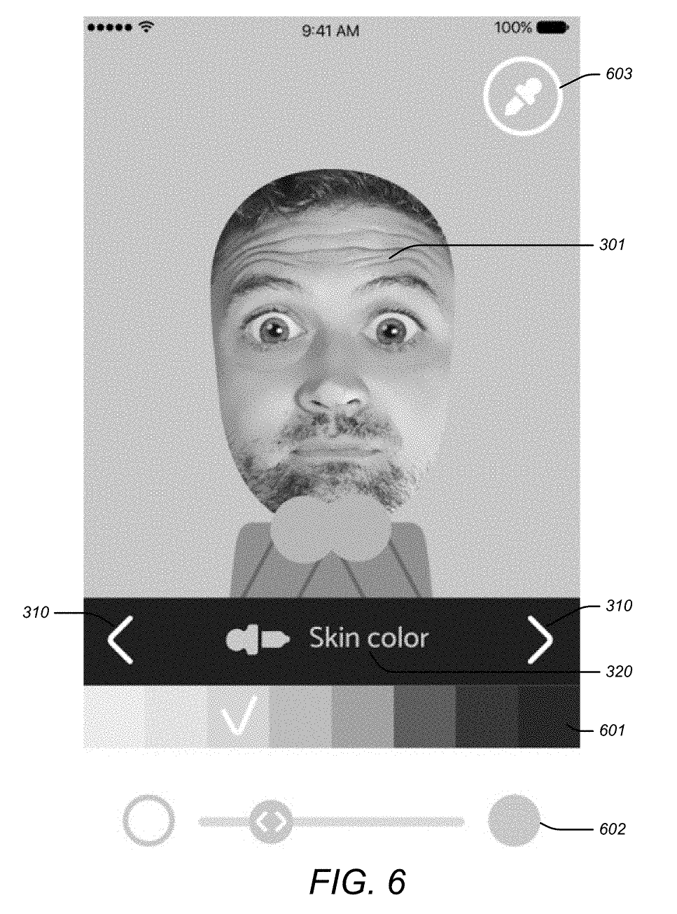

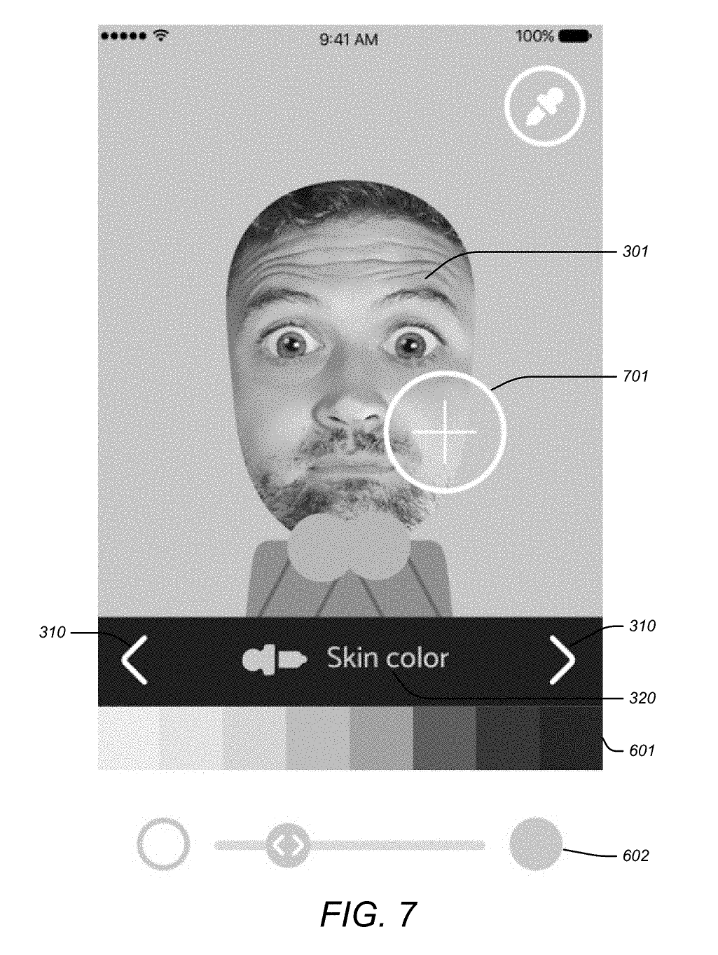

FIGS. 6 and 7 illustrate an example of a skin color customization step that may be presented to the user that may allow the user to select a color for the skin of the avatar.

As illustrated in FIG. 6, the user may choose the skin color of the avatar by actuating a user-actuated control, such as by selecting a color from a set of color samples 601. The user may also adjust the lightness of the selected color by adjusting a user-operated control, such as a lightness slider 602.

A user-operated control, such as a color button 603, may instead allow the user to select a pixel on the image of the face 301 that will serve as the skin color for the avatar, as illustrated in FIG. 7.

The user may continue to progress backwards or forwards through the customization options of the computer software application by using the arrow buttons 310 or by clicking on the current option and selecting another, as explained above in connection with FIGS. 3 and 4.

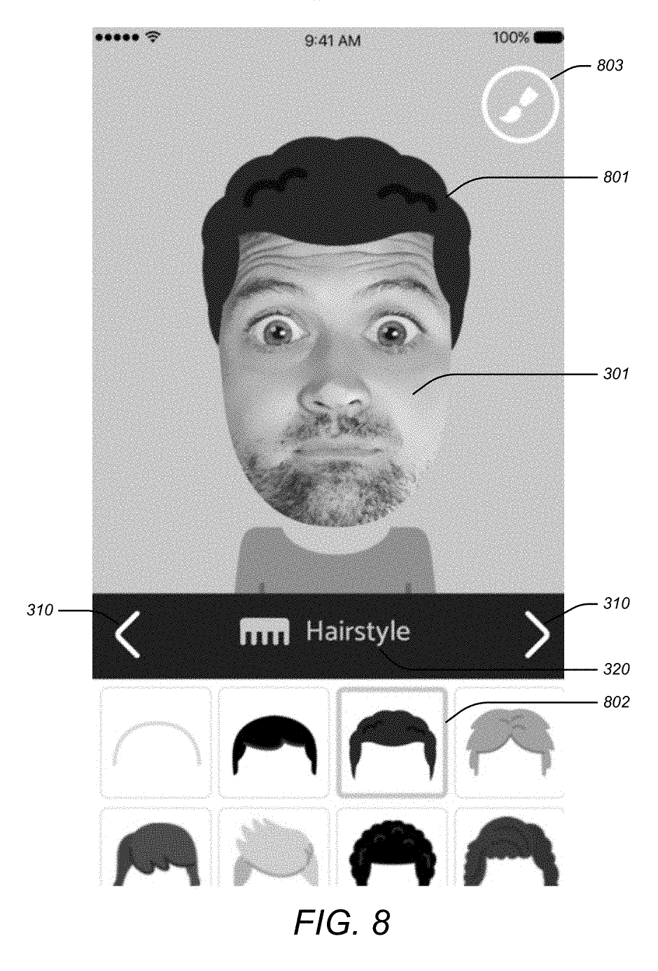

FIG. 8 illustrates an example of a hairstyle selection step that may be presented to the user that may allow the user to select a hairstyle for the avatar. As illustrated in FIG. 8, the user may select a hairstyle 801 from choices presented in a grid 802.

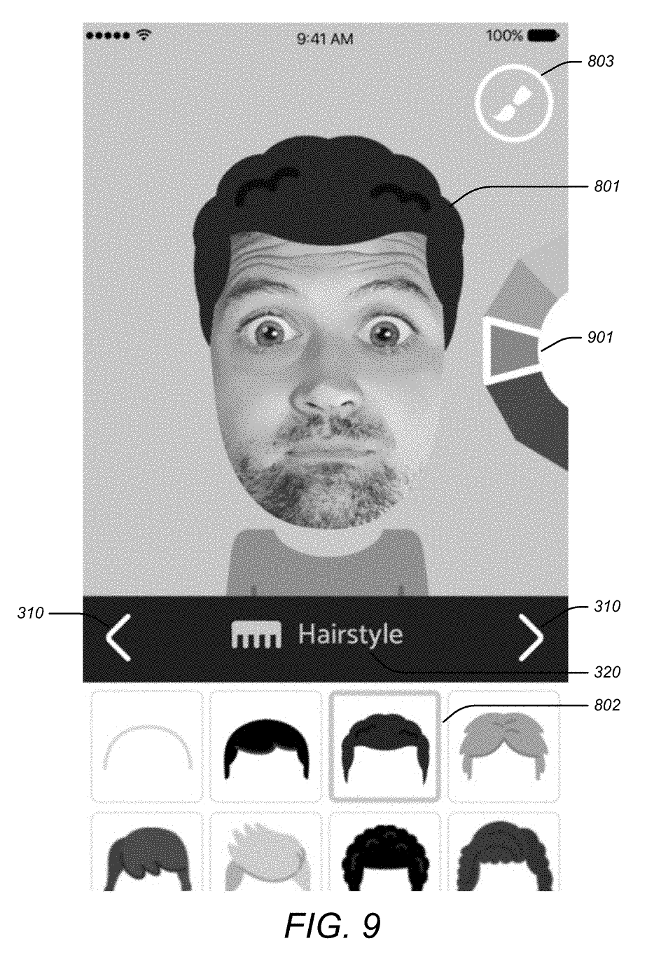

FIG. 9 illustrates an example of a hair color selection step that may be presented to the user that may allow the user to select a color for the selected hair of the avatar. The user can choose the color of the selected hairstyle 801 by actuating a user-actuated control, such as a color selection button 803. As illustrated in FIG. 9, this may open a color selection wheel 901 that may allow the user to select a hairstyle color.

The software application may cause the selected hairstyle in the selected hairstyle color to overlay and replace the actual hair style, as depicted in the captured or selected image of the real face.

The user may continue to progress backwards or forwards through the customization options of the computer software application by using the arrow buttons 310 or by clicking on the current option and selecting another, as explained above in connection with FIGS. 3 and 4.

The process may allow the user to select one or more accessories for the avatar, such as eyeglasses and/or a hat.

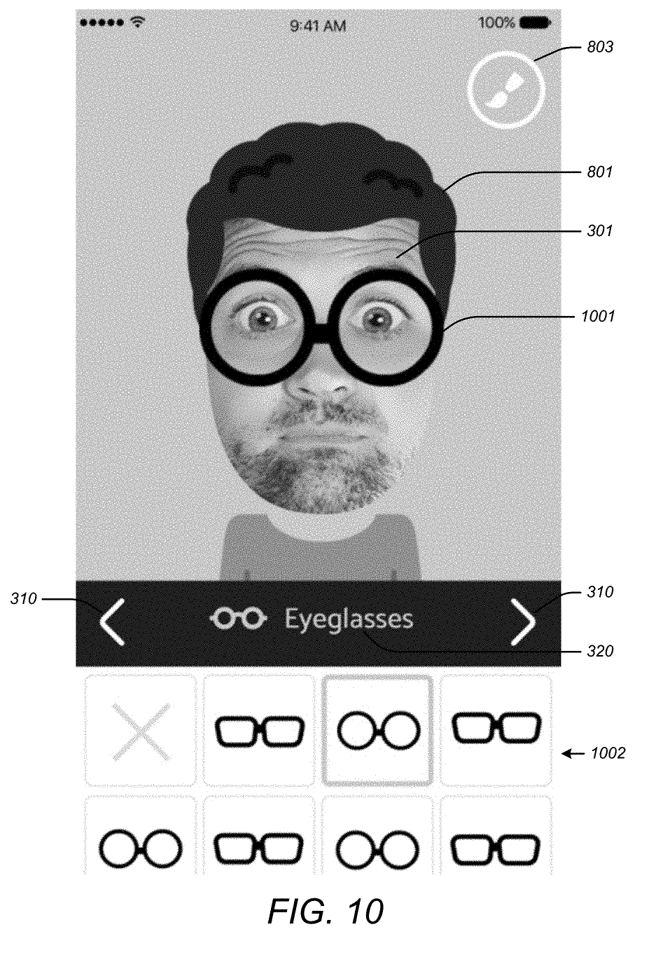

FIG. 10 illustrates an example of a glasses selection step that may be presented to the user that may allow the user to select a style of eyeglasses for the avatar. As illustrated in FIG. 10, the user may select a style of eyeglasses 1001 from a user-operated control, such as from a grid of eyeglasses frame choices 1002.

The user may select the color of the accessory, for example the eyeglasses 1001, by actuating a user-operated control, such as the color button 803.

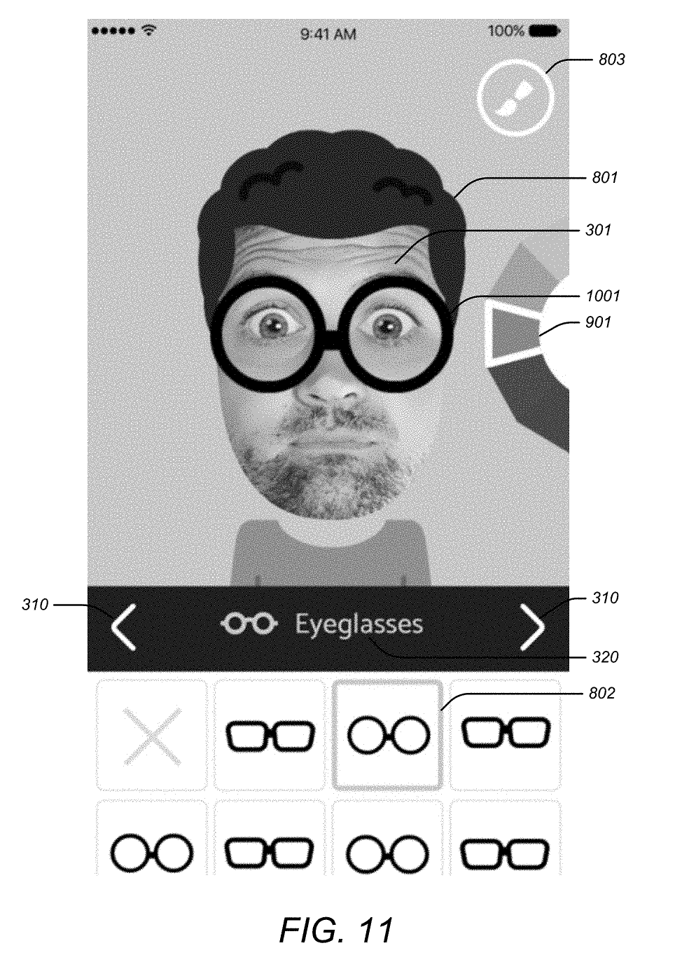

FIG. 11 illustrates an example of an eyeglasses color selection step that may be presented to the user that may allow the user to select a color for the eyeglasses of the avatar. This step may be actuated by tapping the color button 803. As illustrated in FIG. 11, this may open a color selection wheel 901 for the user to select a color. The user may continue to progress backwards or forwards through the customization options of the computer software application by using the arrow buttons 310 or by clicking on the current option and selecting another, as explained above in connection with FIGS. 3 and 4.

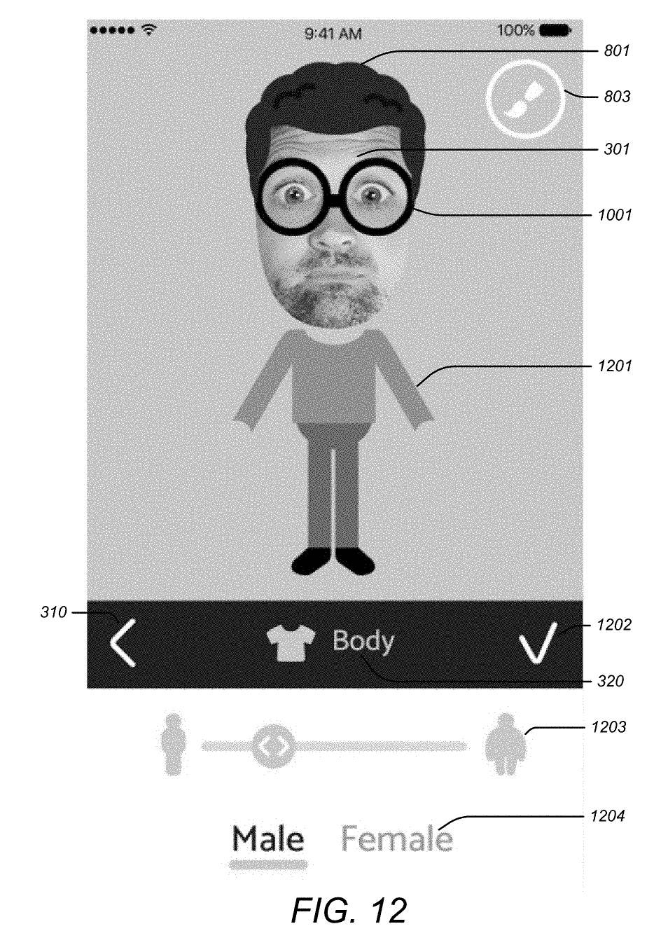

FIG. 12 illustrates an example of a body shape customization step that may be presented to the user that may allow the user to customize the shape of the body of the avatar. As illustrated in FIG. 12, the user may customize the shape of the body of a digital avatar 1201 underneath the image 301 by adjusting a user-operated control, such as a body size slider 1203 and/or by choosing between two gender options 1204. Sliding of the body size slider 2013 may widen or narrow the body of the digital avatar 1201. The male or female gender options 1204 may change the body type of the digital avatar 1201 to reflect either a male or a female shape.

The user may choose colors for different articles of clothing worn by the digital avatar 1201 by tapping the color selection button 803.

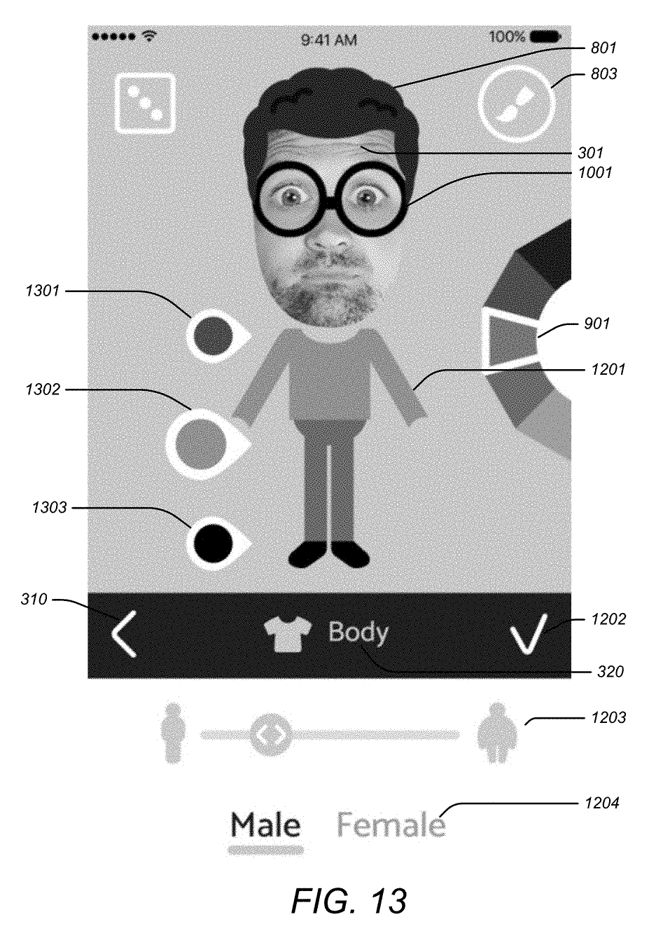

FIG. 13 illustrates an example of a clothing color customization step that may be presented to the user that may allow the user to customize the color of various articles of clothing worn by the avatar. This option may be presented to the user in response to tapping of the color selection button 803 in FIG. 12. As illustrated in FIG. 13, pressing the color selection button 803 may open a color selection wheel 901 for the user to select a color for different clothing worn by the digital avatar 1201. The user interface may include a user-actuated control that allows the user to set a different color for the different articles of clothing. For example, the user may select a color from the color selector wheel 901 and then apply the selected color to a shirt on the avatar by tapping a shirt button 1301, to pants by tapping a pants button 1302, and to shoes by tapping a shoes button 1303. The user may go backwards through the customization options of the computer software application by using the arrow buttons 310 or by clicking on the current option and selecting another, as explained above in connection with FIGS. 3 and 4.

The user may complete the customization process of the digital avatar 1201 by actuating a user-operated control, such as by tapping a checkmark button 1202.

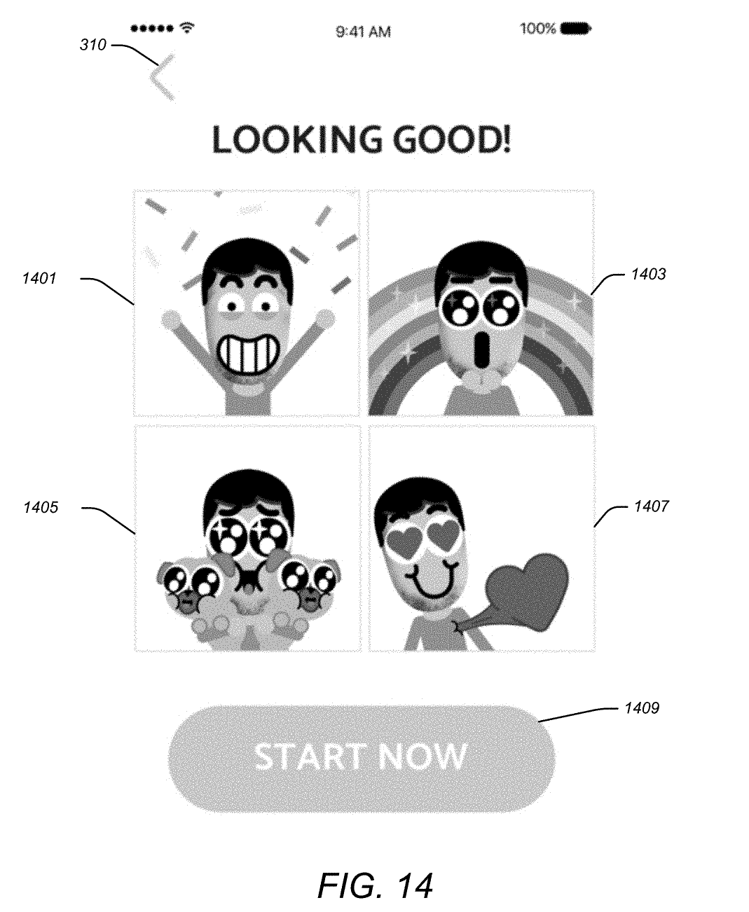

FIG. 14 are examples of various animated avatar previews that the software application may create and present based on the customization selections made by the user during the steps illustrated in FIGS. 1-13. As illustrated in FIG. 14, a grid of animated selectable digital avatar animations may be presented, such as animated avatars 1401, 1403, 1405, and 1407. Each animated avatar may present a pre-fabricated sequence of animation frames which may include layers of 2D and 3D animation and optionally text. One or more of these animation frames, however, may be edited by the software application to include customizations dictated by the user, such as the customizations that are the subject of FIGS. 1-13. Each animated selection may preview the animation with all of the requested customizations.

The user may select one of the customized animations, such as by tapping the animation. The user may then signal completion of the selection by tapping a Start Now button 1409.

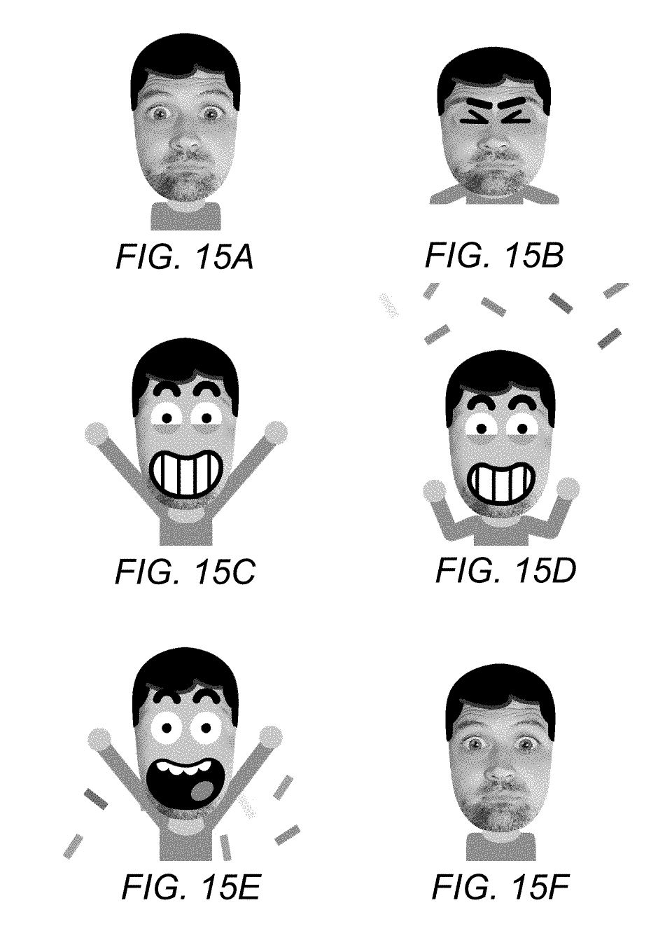

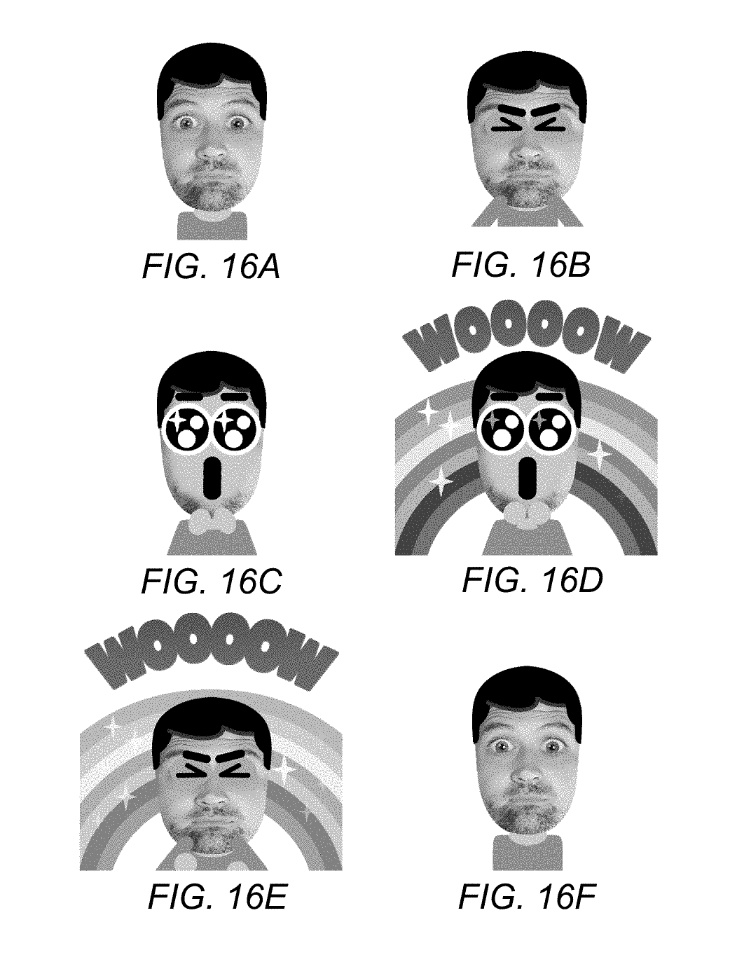

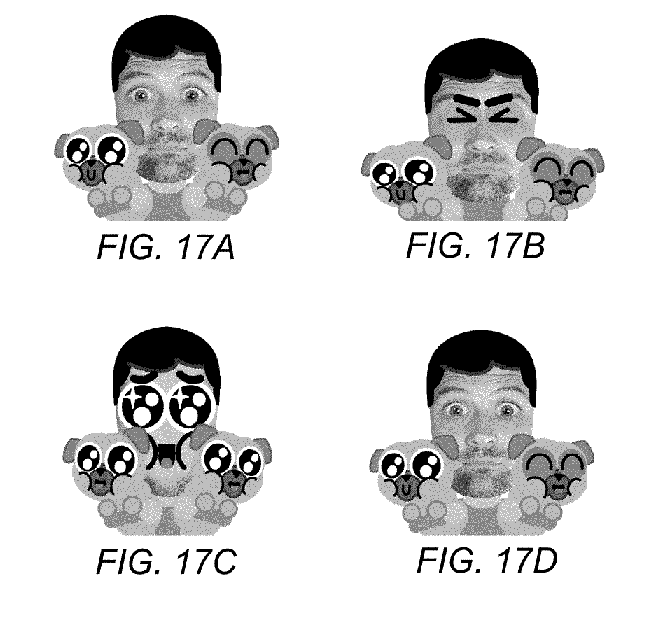

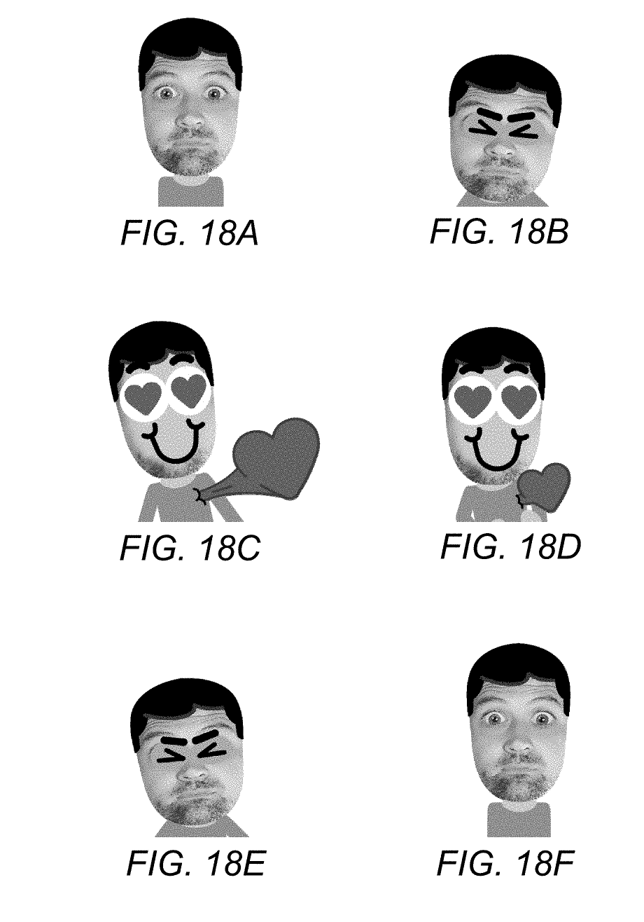

FIGS. 15A-15F are some of the frames that comprise the example avatar animation 1401 illustrated in FIG. 14; FIGS. 16A-16F are some of the frames that comprise the example avatar animation 1403 illustrated in FIG. 14; FIGS. 17A-17D are some of the frames that comprise the example avatar animation 1405 illustrated in FIG. 14; and FIGS. 18A-18F are some of the frames that comprise the example avatar animation 1407 illustrated in FIG. 14.

FIGS. 15A-15F, 16A-16F, 17A-17D, and 18A-18D illustrate for each animation the results of the software editing one or more drawn frames in a pre-determined set of drawn frames to reflect one or more of the customizations that the user specified, as discussed above. Various specific examples of the types of editing that may be performed are now described.

FIGS. 15A, 16A, 17A, and 18A each show an example of the first frame of its respective animation. In each example, the captured or selected image of the real photographed face has been substituted, with all of the customizations that were made to this real face. This real face is displayed on top of a template animation of a portion of an avatar body that uses the customized skin color for the neck and the customized shirt color for the shirt.

FIGS. 15B, 16B, 17B, and 18B each show an example of a subsequent frame in the animation being further modified to show a drawn set of eyes and a drawn set of eyebrows above them replacing the real eyes. The software may first place a skin colored overlay over the set of real eyes in each instances to facilitate this modification.

FIGS. 15C, 16C, 17C, and 18C each show an example of a subsequent frame in the animation being further modified to show a drawn mouth replacing the real mouth. These figures also illustrated how the software has completely eliminated a feature of the captured or selected real face, the nose in these examples. The software may similarly first place a skin colored overlay over the real mouth and nose in each instances to facilitate these modifications. These figures also illustrate how drawn features such as the eyes and eyebrows may change during the sequence.

FIGS. 16D and 16E illustrate examples of text that may be included.

FIGS. 15F, 16F, 17D, and 18F show the last frame in each animation which, in these examples, may be substantially the same as the first frame.

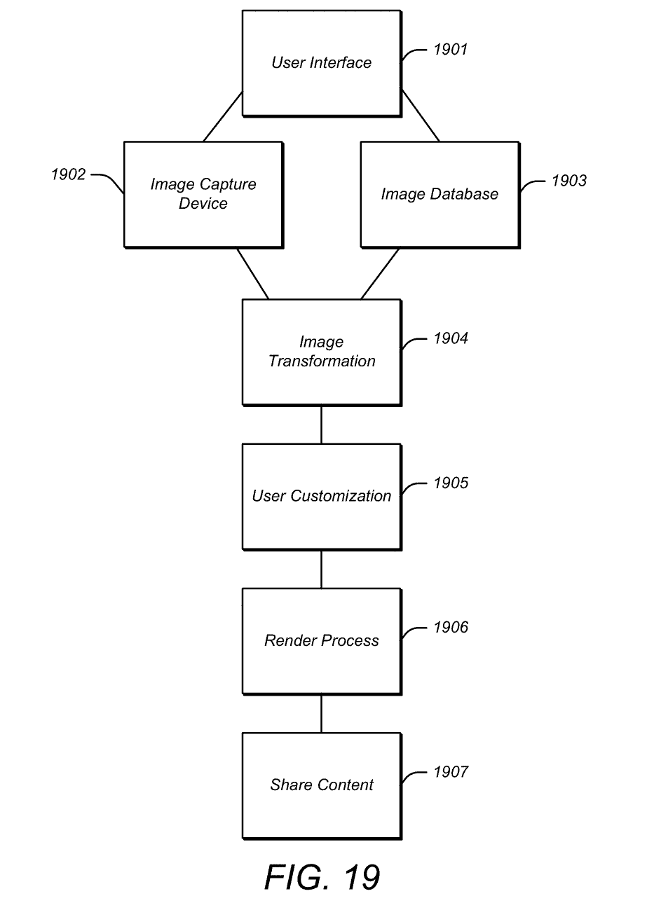

FIG. 19 is an example of a flow diagram of a process that may be followed to create and share a customized animated digital avatar that includes a photographed image of a face. As illustrated in FIG. 19, the user may be presented with a user interface in a user interface step 1901 upon opening the computer software application. The user may then take a picture using an image capture device that may be part of the mobile device running the computer software application in an image capture step 1902, or the user may select an image from an image database in an image database step 1903, such as, for example, from local storage of the mobile device.

The captured or selected image may be customized in an image transformation step 1904, during which the computer software application may determine specifications and apply features to the selected or captured image, such as, for example, smoothing, face shape, skin color, and eye color. Examples of such transformations are described above. The software may use an algorithm to transform the selected or captured image to partially resemble a 2D cartoon illustration. To do so, the computer software application may use facial detection to detect the facial features, such as eyes or nose, and apply image effects to adjust only the selected features of the face, such as enlarging the eyes or smoothing the skin. This step may be accomplished by implementing a commercial product that can be purchased or licensed, such as the commercially-available application program interface “Core Image” offered by Apple Inc., which is more fully described on Apple's website.

The image and 2D illustrated body, collectively referred to herein as the digital avatar, may then open to user customization in a user customization step 1905. One or more of the customization options described above may be used, as well as others.

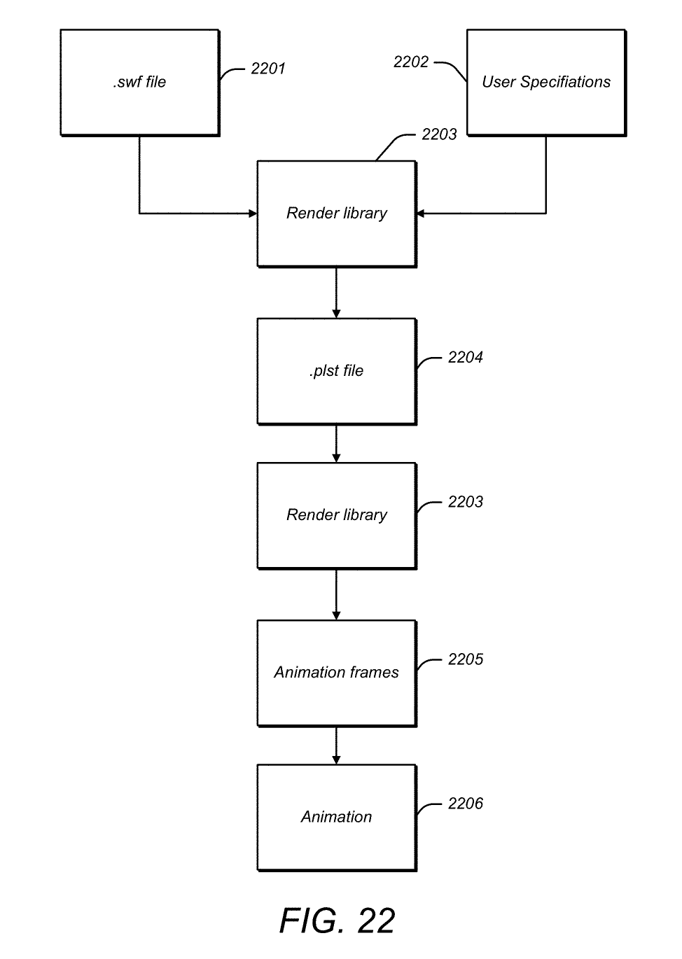

The digital avatar may then be rendered during a render process step 1906, an example of which is described below in connection with FIG. 22. This may result in the production of a collection of animated digital avatars, such as animated avatars 1401, 1403, 1405, and 1407 discussed above.

The generated animated digital avatar(s) may then be shared during a share content step 1907. The sharing may take place, for example, by a placing the animation in an instance message, text, or in social media platforms.

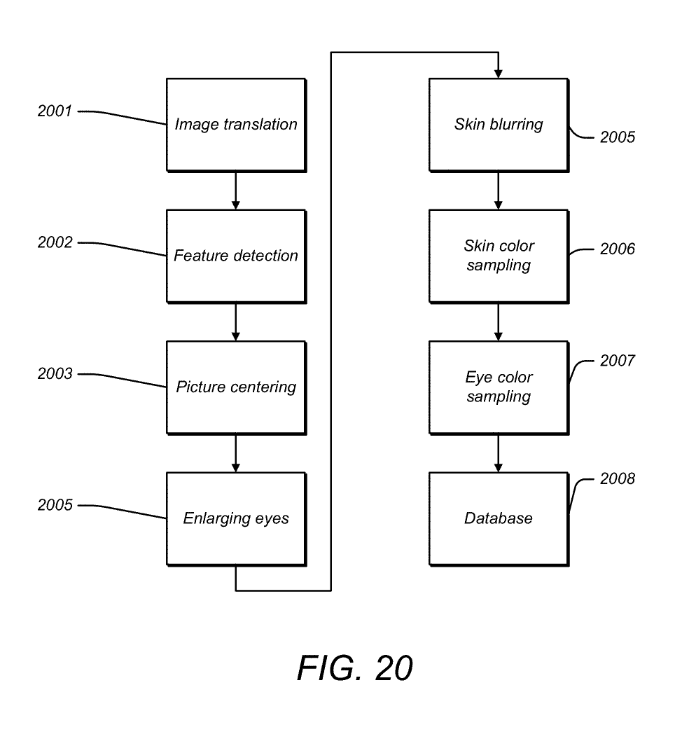

FIG. 20 is an example of a flow diagram of automated steps in a process that may be followed to create and store a customized animated digital avatar that includes a photographed image of a face. As illustrated in FIG. 20, the computer software application may customize the selected or captured image and store specification data of this customization in a database.

An image translation step 2001 may use computer software to receive an image file type by reading a compatible file type and displaying the image on a display.

A feature detection step 2002 may use an algorithm to detect the presence of one or more feature in the image, such as, for example, the eyes, by using facial detection to detect the eyes and applying image effects to adjust only the selected features of the face. This step may be accomplished by implementing a commercial product that can be purchased or licensed, such as the commercially-available application program interface “Core Image” offered by Apple Inc., which is more fully described on Apple's website.

The computer software application may use an algorithm to center the selected or captured image within the pre-determined border 305 and to determine a default face shape 303 during a picture centering step 2003. This step may be accomplished by implementing a commercial product that can be purchased or licensed, such as the commercially-available application program interface “Core Graphics” offered by Apple Inc., which is more fully described on Apple's website.

The computer software application may use an algorithm to reduce or enlarge one or more features of the face, but not the others, such as the eyes detected in the eye detection step 2002, such as to enlarge the eyes as reflected in an enlarging eyes step 2004.

The computer software application may use an algorithm to smoothen and remove specific features of the incorporated image, such as the eyes, nose or mouth, and then overlay a corresponding 2D cartoon illustration of this feature during a skin blurring step 2005.

The computer software application may sample the color of the skin of the captured or the incorporate image in a skin color sampling step 2006. The software may cause the exposed skin of the animated avatar to match, such as its hands.

The computer software application may sample the color of the eyes of the captured or the incorporate image in eye color sampling step 2007. The software may cause drawn eyes that may be substituted for the photographed eyes to have the same color.

The specifications applied or determined during steps 2002 through 2007 steps may be stored in a database for use during step 1905 and 1906 shown in FIG. 15, as reflected by a database step 2008.

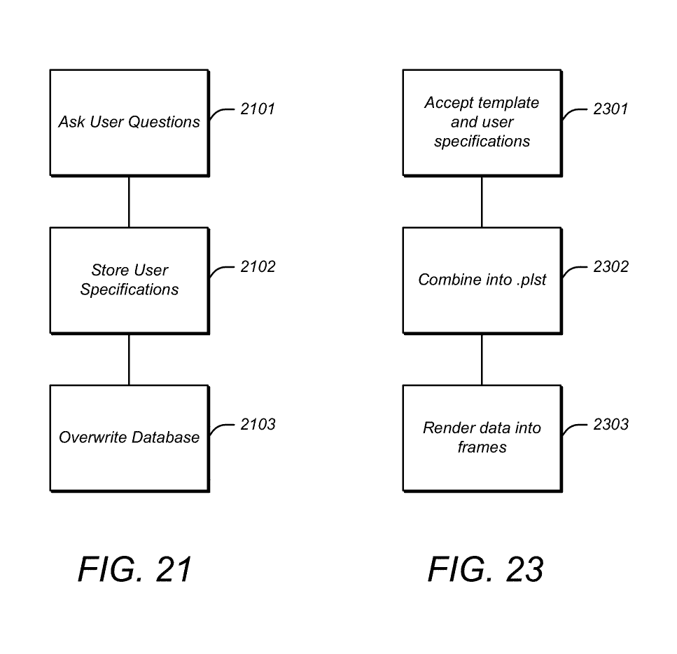

FIG. 21 is an example of a flow diagram of steps in a process that may be followed by a user to customize different features of the digital avatar. As illustrated in FIG. 21, the computer software application may ask the user for specifications to customize in an ask user questions step 2101. Examples of such specifications are detailed in FIG. 3-13. Some of these specifications may have default values, which may be taken from the database that the specifications were stored in during the database step 2008, such as, for example, providing a skin color for the digital avatar that already matches the skin color of the captured or selected image, reducing the need for user customization. The computer software application may overwrite and store any user-changed specifications in the database in an overwrite database step 2103.

FIG. 22 is an example of a flow diagram of steps in a process that may be followed by a user to create an animated digital avatar by combining different file types in a render library. As illustrated in FIG. 22, the computer software application may render the animated digital avatar by combining a .swf file 2201 and user specifications 2202 from the database taken from the overwrite database step 2103 during a render library step 2203. The render library step 1803 may create a .plist file 2204, which may include the specifications for the digital avatar, such as, for example, eye color, skin color, hairstyle, accessory, gender, and body type. The render library step 2203 may translate the .plist file 2204 into a set of animation frames 2205 made up of 2D illustrated images, such as the frames shown in FIGS. 15-18, which may then be rendered in a timed sequence to create an animation image 2206, such as, for example, a digital avatar with the animated facial expressions 1401, 1403, 1405, and 1407.

FIG. 23 is an example of a flow diagram of steps in a process that may be followed in connection with a render library to combine different file types to create a collection of frames for animating a digital avatar. As illustrated in FIG. 23, the computer software application may take in a template for animation, for example, an .swf file, and user specifications in an accept template and user specifications step 2301. The template for animation may include the data and resources required for rendering a digital avatar into an animation, but may have default features, such as a standard facial image, clothing color, and/or skin color. The template for animation may then be combined with the user specifications, examples of which are detailed in FIG. 3-13, to create a file type, for example a .plist, which contains both the template for animation and the user specifications in combination, as reflected in a combine into .plist step 2302. The user specifications may adjust the default features included in the template for animation to reflect the user selections made in FIG. 21. The computer software application may then take the data contained in the .plist and render the data into a collection of frames, such as in FIGS. 15-18, that, when played in timed sequence, become an animated digital avatar, in a render data into frames step 2303.

Each of the various processes and algorithms that have been discussed may be implemented with a specially-configured computer data processing system specifically configured to perform these processes and algorithms. The computer data processing system may include one or more processors, tangible memories (e.g., random access memories (RAMs), read-only memories (ROMs), and/or programmable read only memories (PROMS)), tangible storage devices (e.g., hard disk drives, CD/DVD drives, and/or flash memories), system buses, video processing components, network communication components, input/output ports, and/or user interface devices (e.g., keyboards, pointing devices, displays, microphones, sound reproduction systems, and/or touch screens).

The computer data processing system may be a desktop computer or a portable computer, such as a laptop computer, a notebook computer, a tablet computer, a PDA, or a smartphone.

The computer data processing system may include one or more computers at the same or different locations. When at different locations, the computers may be configured to communicate with one another through a wired and/or wireless network communication system.

The computer data processing system may include software (e.g., one or more operating systems, device drivers, application programs, and/or communication programs). When software is included, the software includes programming instructions and may include associated data and libraries. When included, the programming instructions are configured to implement one or more processes and algorithms that implement one or more of the functions of the computer data processing system, as recited herein. The description of each function that is performed by each computer system also constitutes a description of the algorithm(s) that performs that function.

The software may be stored on or in one or more non-transitory, tangible storage devices, such as one or more hard disk drives, CDs, DVDs, and/or flash memories. The software may be in source code and/or object code format. Associated data may be stored in any type of volatile and/or non-volatile memory. The software may be loaded into a non-transitory memory and executed by one or more processors.

The components, steps, features, objects, benefits, and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits, and/or advantages. These also include embodiments in which the components and/or steps are arranged and/or ordered differently.

For example, the animated avatar may not have a body, but only an animated face. The animated avatar may include text or other effects beyond facial features that change from frame to frame. The computer software may allow the user to include more than one digital avatar in the animation. The animated avatar may include sounds.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases from a claim means that the claim is not intended to and should not be interpreted to be limited to these corresponding structures, materials, or acts, or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element proceeded by an “a” or an “an” does not, without further constraints, preclude the existence of additional elements of the identical type.

None of the claims are intended to embrace subject matter that fails to satisfy the requirement of Sections 101, 102, or 103 of the Patent Act, nor should they be interpreted in such a way. Any unintended coverage of such subject matter is hereby disclaimed. Except as just stated in this paragraph, nothing that has been stated or illustrated is intended or should be interpreted to cause a dedication of any component, step, feature, object, benefit, advantage, or equivalent to the public, regardless of whether it is or is not recited in the claims.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

The invention claimed is:

1. A non-transitory, tangible, computer-readable storage media that contains a computer file that contains a set of animation frames that, when displayed sequentially, illustrate an animated face that has one or more facial features that change during the animation, each change being between a photographed facial feature of a real face and a corresponding drawn facial feature of a drawn face.

2. The storage media of claim 1 wherein the one or more facial features that change include eyes.

3. The storage media of claim 1 wherein the one or more facial features that change includes a mouth.

4. The storage media of claim 1 wherein the one or more facial features that change includes a nose.

5. The storage media of claim 1 wherein the one or more facial features that change includes eyebrows.

6. The storage media of claim 1 wherein the one or more facial features that change includes eyeglasses.

7. The storage media of claim 1 wherein the expression of the face changes during the animation.

8. The storage media of claim 1 wherein at least one of the animation frames is of a face without a nose.

9. The storage media of claim 1 wherein all of the frames include one or more of the facial features of the photographed image of the face.

10. An automated method of displaying a photographed image of a real face centered within a pre-determined border comprising a computer data processing system having a processor:
receiving image data that includes a photographed image of a real face;
detecting the size and location of the real face within the photographed image;
superimposing a pre-determined border on the photographed image;
adjusting the size and location of the photographed image of the real face relative to the pre-determined border automatically and without user input during the adjusting so as to cause the photographed image of the real face to be centered within and to fill the area within the pre-determined border; and
displaying the real face centered within and filling the area within the pre-determined border.

11. The automated method of claim 10 wherein the computer data processing system also:
rotates the photographed image of the real face with respect to the pre-determined border so that the eyes in the real face are centered about the same horizontal axis; and
displays the photographed image of the real face within the pre-determined border with the eyes in the real face centered about the same horizontal axis.

12. A method of generating a computer file that contains a set of animation frames that, when displayed sequentially, illustrate an animated face, the method comprising a computer data processing system having a processor:
receiving template data indicative of a set of template animation frames, each having a template face, that, when displayed sequentially, illustrate a template animated face;
reading customization data indicative of one or more desired changes to at least one of the template animated frames, including the substitution of a photographed image of a real face for the template animated face in the template animated frame; and
generating a computer file that contains a set of animation frames that, when displayed sequentially, illustrate an animated face that has all of the features of the template animated face, except for the changes dictated by the customizing data.

13. The method of claim 12 wherein the set of animation frames, when displayed sequentially, illustrate an animated face that has one or more facial features that change during the animation, each change being between a facial feature in the photographed image of the real face and a corresponding drawn facial feature of a face.

14. A method of generating a computer file that contains an image of a real face comprising a computer data processing system having a processor:
receiving data indicative of a photographed image of a real face;
changing the size of at least one but not all of the features in the real face automatically and without user input during the changing; and
generating a computer file containing the data indicative of a photographed image of a face, but with the changed size of the at least one but not all of the features in the real face.

15. The method of claim 14 wherein one of the features of the real face whose size is changed is the eyes of the real face.

16. The method of claim 14 further comprising the computer data processing system smoothing the skin of the photographed image of the real face and wherein the generated computer file includes the smoothened skin of the photographed image.

17. A method of generating a computer file that contains an image of a real face comprising a computer data processing system having a processor:
receiving data indicative of a photographed image of a real face;
presenting a linked sequence of user interface screens, each user interface screen allowing a user to modify a different feature of the photographed image of the real face;
receiving one or more user instructions to modify the image of the real face during the presenting of the user interface screens; and
generating a computer file that contains the image of the real face, modified as specified by the user instructions.

18. The method of claim 17 wherein the generated computer file contains a set of animation frames that, when displayed sequentially, illustrate an animation of the real face, at least one of the frames including the modifications specified by the one or more user instructions.

19. The method of claim 17 wherein:
one of linked sequences of user interface screens presents a proposed default shape for the face that is automatically set by the computer data processing system and that allows the user to modify this proposed default shape;
one of the received user instructions is to modify the proposed default shape of the face; and
the computer file contains the image of the real face with the modification to its shape and any other modifications dictated by the user instructions.

20. The method of claim 17 wherein:
one of linked sequences of user interface screens presents a proposed default hairstyle above the face that is automatically set by the computer data processing system and that allows the user to modify this proposed default hairstyle;
one of the received user instructions is to modify the proposed default hairstyle above the face; and
the computer file contains the image of the real face with the modification to its hairstyle and any other modifications dictated by the user instructions.

21. The method of claim 17 wherein:
one of linked sequences of user interface screens presents a proposed default smoothness for the skin of the face that is automatically set by the computer data processing system and that allows the user to modify this proposed default smoothness;
one of the received user instructions is to modify the proposed default smoothness of the face; and
the computer file contains the image of the real face with the modification to its smoothness and any other modifications dictated by the user instructions.

22. The method of claim 17 wherein:
one of linked sequences of user interface screens presents a proposed default lighting for the face that is automatically set by the computer data processing system and that allows the user to modify this proposed default lighting;
one of the received user instructions is to modify the proposed default lighting of the face; and
the computer file contains the image of the real face with the modification to its lighting and any other modifications dictated by the user instructions.

23. The method of claim 17 wherein:
one of linked sequences of user interface screens presents a proposed default avatar having the real face and other skin of the avatar having a proposed default color that is automatically set by the computer data processing system and that allows the user to modify this proposed default color;
one of the received user instructions is to modify the proposed default color of the other skin of the avatar; and
the computer file contains the image of the avatar with the modification to the proposed default color of the other skin of the avatar and any other modifications dictated by the user instructions.

24. The method of claim 17 wherein:
one of linked sequences of user interface screens presents a proposed default avatar having the real face and a proposed default shape for a body of the avatar that is automatically set by the computer data processing system and that allows the user to modify this proposed default shape;
one of the received user instructions is to modify the proposed default shape of the body of the avatar; and
the computer file contains the image of the avatar with the modification to the proposed default shape of the body of the avatar and any other modifications dictated by the user instructions.

25. The method of claim 17 wherein:
one of linked sequences of user interface screens presents a proposed default avatar having the real face and an article of clothing that is worn by the avatar that has a proposed default color that is automatically set by the computer data processing system and that allows the user to modify this proposed default color;
one of the received user instructions is to modify the proposed color of the article of clothing; and
the computer file contains the image of the avatar with the modification to the proposed default color of the article of clothing and any other modifications dictated by the user instructions.

26. A method of generating a computer file that contains a set of animation frames that, when displayed sequentially, illustrate an animated avatar, the method comprising a computer data processing system having a processor:
receiving data indicative of a photographed image of a real face;
locating an eye within the photographed image of the real face;
identifying a color of the located eye; and
generating a computer file that contains a set of animation frames that, when displayed sequentially, illustrate an animated avatar that includes at least portions of the photographed image of the real face, at least one of the animation frames having drawn eyes of the same color as the identified color of the located eye.
